(19) United States
(12) Patent Application Publication
(10) Pub. No.: US 2004/0221498 A1
(43) Pub. Date: Nov. 11, 2004

(54) Vehicle pass holder

(76) Inventors: Gregory Vico, Jamison, PA (US); Paul Vico, Saddle Brook, NJ (US)

Correspondence Address: Richard C. Litman, LITMAN LAW OFFICES, LTD., P.O. Box 15035, Arlington, VA, 22215, US

(21) Appl. No.: 10/837,615

(22) Filed: May 4, 2004

Related U.S. Application Data
(60) Provisional application No. 60/468,881, filed on May 8, 2003.

(51) Int. Cl. G09F 21/04

(52) U.S. Cl. 40/593; 40/597; 40/643

(57) ABSTRACT

A device that is removably attachable to an interior surface of an automobile. The device includes a body portion defined by a planar surface area. A spring-clip fastening structure is attached to the body portion. The spring-clip functions to fasten identification information, such as a security pass, to the body portion. The body portion is provided with a beveled area, which area has an opening formed to receive a suction cup. The suction cup is employed to attach the device to an interior surface of the automobile. The planar surface area of the body is utilized to display advertisement media.

### CROSS-REFERENCE TO RELATED APPLICATION

This application claims the benefit of U.S. Provisional Patent Application Serial No. 60/468,881, filed May 8, 2003.

### BACKGROUND OF THE INVENTION

1. Field of the Invention

The present invention relates to display devices. More specifically, the present invention is drawn to a device which attaches to an inside surface of an automobile, which device is utilized to display identification information.

2. Description of the Related Art

Always a concern, security has become an urgent issue since the events of 9/11. Government and private agencies are constantly striving to improve accuracy and speed when identifying individuals. One of the more common forms of identification employed is the security pass. The security pass usually has identification indicia printed on the front surface. The security pass is especially adaptable when displayed for view through the windshield of an automobile. The display of a proper security pass is often required before entry can be gained to facilities such as gated communities, tourist resorts, industrial plants, etc. Carrying the pass in one's pocket cumbersome in that the pass must sometimes be retrieved while the vehicle is in motion, thereby creating a hazardous situation. There have been unsuccessful attempts to secure the pass to the dashboard or mount the pass on the mirror of the automobile. A device that could be removably attached to an interior surface in an automobile, which device would efficiently display security information and also function as an advertisement source would most certainly be a welcome addition to the art.

The related art is rife with display devices for automotive vehicles and the like. For example, U.S. Pat. No. 1,632,856 (Running) discloses a suction cup device adapted to hold a roadmap. No provision is made to provide space for advertisement on the device.

U.S. Pat. No. 6,446,375 B1 (Davis) shows a lightweight, slightly curved envelope that is attached automotive vehicle windows with suction cups. Advertisement message sheets are disposed in the envelope. The patentee contemplates the use of at least two suction cups and makes no provision for the display of security information through the front windshield of the vehicle.

U.S. Pat. No. 6,131,865 (Adams) and U.S. Pat. No. 6,367,184 B1 (Kheder) are drawn to suction cup devices adapted to support signs. The patentees do not contemplate providing a combination advertisement and security information display device.

U.S. Pat. No. 4,813,640 (Perentin) shows a suction cup adapted to support a needle therefrom. There is no structure for retaining a security pass or for the display of advertisements.

The Shapiro U.S. Pat. No. 4,671,482 is drawn to a device for holding a trip map and a toll ticket. The device comprises plural parts and is adhesively affixed to a supporting surface.

U.S. Pat. No. 5,613,659 (Hong) discloses suction devices having sheet pressing ability. The suction devices incorporate relatively complicated structure and include no surfaces for advertisement.

U.S. Pat. No. Des. 350,104 (Lee) shows a design for a display holder for vehicles. There appears to be no structure for removably supporting a security pass.

French Patent numbered 2,650,104 (Jacques) discloses a box for display of parking tickets and/or receipts through plural windows in the box. No provision is made to include advertisement space on the box.

None of the above inventions and patents, taken either singly or in combination, is seen to disclose a vehicle pass holder, which will subsequently be described and claimed in the instant invention.

### SUMMARY OF THE INVENTION

The present invention is a device that is removably attachable to an interior surface of an automobile. The device includes a body portion defined by a planar surface area. A spring-clip fastening structure is attached to the body portion. The spring-clip functions to fasten identification information, such as a security pass or parking pass, to the body portion. The body portion is provided with a beveled area, which area has an opening formed therethrough. A suction cup is disposed in the opening. The suction cup is employed to attach the device to an interior surface of the automobile. The planar surface area of the body is utilized to display advertisement media. Although described as attached to an automobile vehicle, it is obvious that the device may be attached to vehicles such as motorcycles, golf carts or stationary objects such as refrigerators, windows, etc. It is also obvious that information other than security related data may be fastened to the device.

Accordingly, the instant invention presents a device that is effective in attaching security information to the windshield or an interior surface of an automobile. The device may be readily removed from the windshield or interior surface if desired. The device also incorporates a planar surface area that may be utilized to display advertisement media that will assist businesses in reaching potential customers. The invention provides for elements and arrangements thereof for the purposes described which are inexpensive, dependable and fully effective in accomplishing their intended purposes.

A clear understanding of the invention will become readily apparent upon further review of the following specification and drawings.

### BRIEF DESCRIPTION OF THE DRAWINGS

FIG. 1 is an environmental, perspective view of a vehicle pass holder according to the present invention.

FIG. 2 is a perspective, front view of a first embodiment of a vehicle pass holder according to the present invention.

FIG. 3 is a perspective, rear view of a first embodiment of a vehicle pass holder according to the present invention.

FIG. 4 is a side view of a first embodiment of a vehicle pass holder according to the present invention.

FIG. 5 is a perspective, front view of a second embodiment of a vehicle pass holder according to the present invention.

Similar reference characters denote corresponding features consistently throughout the attached drawings.

### DETAILED DESCRIPTION OF THE PREFERRED EMBODIMENTS

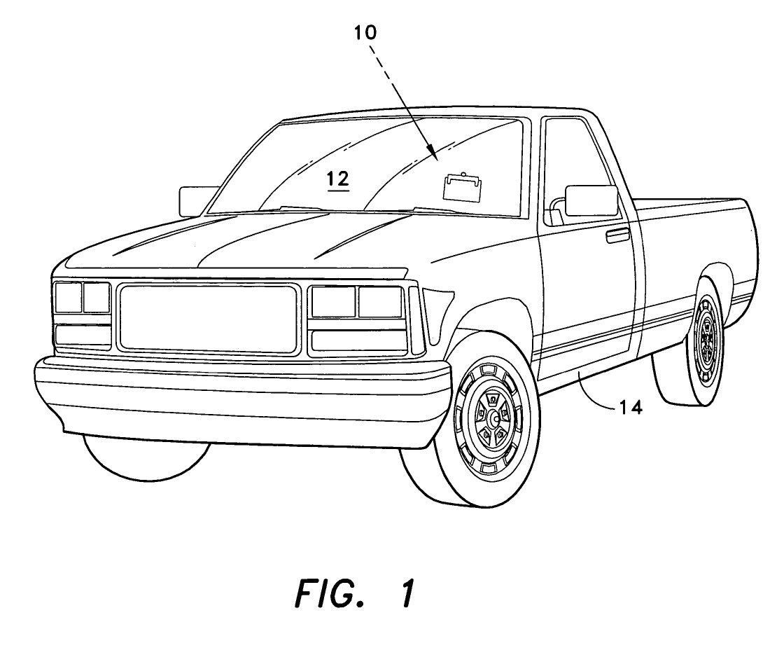

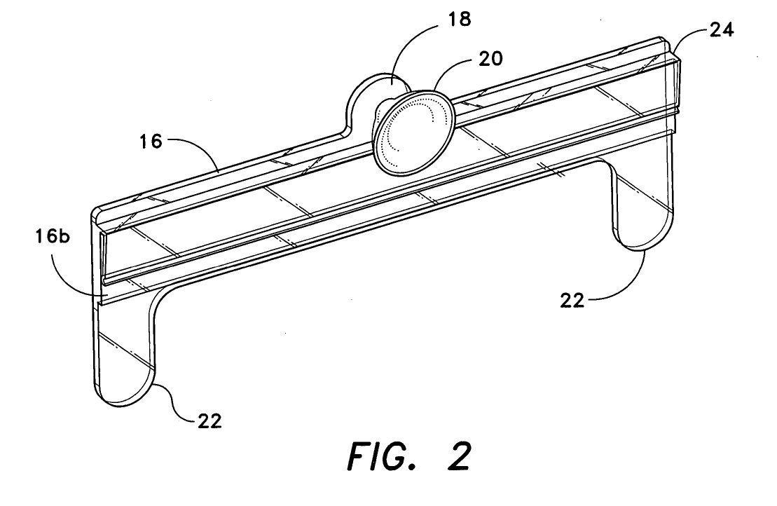

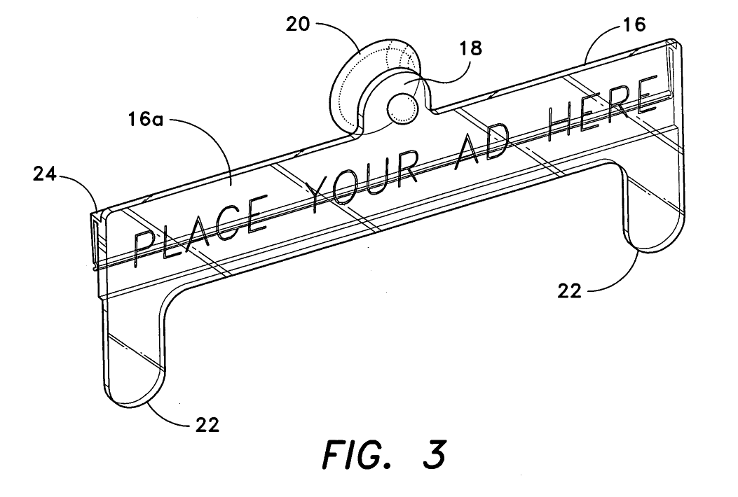

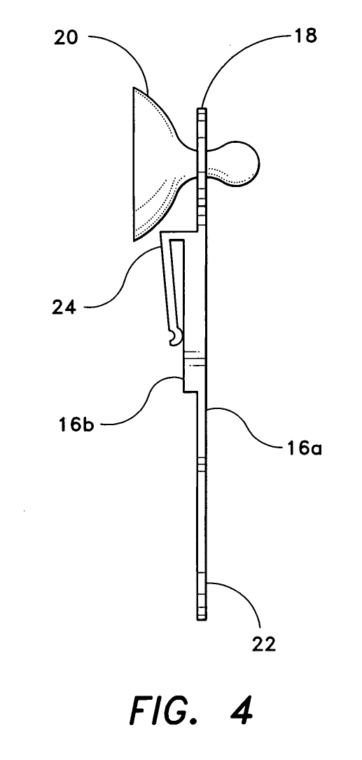

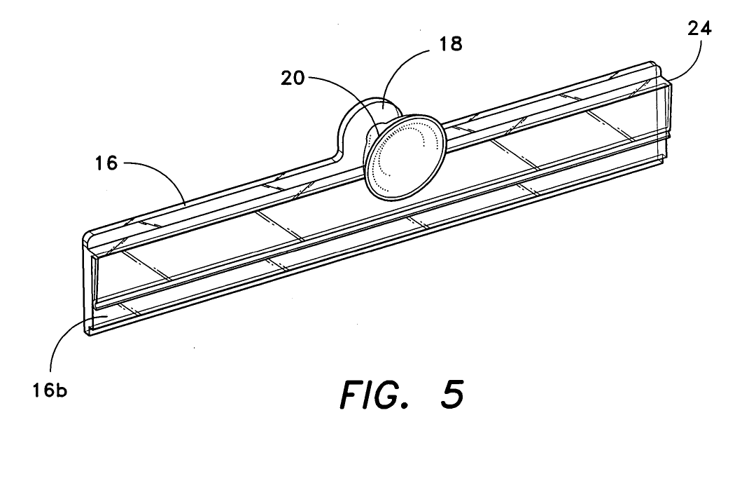

Attention is first directed to FIG. 1, wherein the device of the present invention is generally indicated at 10 and is attached to the inside of windshield 12 of vehicle 14. As best seen in FIGS. 2-4, a first embodiment of the device includes a body portion 16 having a planar rear surface area 16a. A beveled portion 18 is formed on the upper edge of body 16. Portion 18 has an opening therein for receiving a suction cup 20. A pair of legs 22 extends downward from body 16. Legs 22 function as bearing surfaces where needed. A spring-clip structure 24 is formed on the front surface 16b of body 16. The spring-clip has a length coextensive with the length of body 16. As contemplated, the body and spring-clip are fabricated from clear plastic material. The body has advertisement media disposed on the rear surface area 16a. The media may be printed on the surface or applied thereto on removable stickers. All parts are pre-assembled. The embodiment shown in FIG. 5 is similar to the embodiment disclosed above except that the legs have been omitted. This omission lowers production costs.

It is to be understood that the present invention is not limited to the embodiments described above, but encompasses any and all embodiments within the scope of the following claims.

We claim:

1. A vehicle pass holder, comprising:
a body member, said body member having a flat, planar rear surface, a top edge, a bottom edge and a front surface;
a beveled member positioned on said top edge;
an opening disposed through said beveled member;
a spring-clip member disposed on said front surface; and
a suction cup supported in said opening.

2. The vehicle pass holder according to claim 1, wherein said body member has a length and wherein said spring-clip member is coextensive with the length of said body member.

3. The vehicle pass holder according to claim 1, wherein a pair of legs extend from said bottom edge of said body member.

4. The vehicle pass holder according to claim 1, wherein advertisement indicia is disposed on said planar rear surface.

5. The vehicle pass holder according to claim 1, wherein said body member is fabricated from a clear plastic material.

6. The vehicle pass holder according to claim 1, wherein said spring-clip member is fabricated from a clear plastic material.

7. A vehicle pass holder, comprising:
a body member, said body member having a flat, planar rear surface, a top edge, a bottom edge and a front surface, said body member being fabricated from a clear plastic material;
a beveled member positioned on said top edge;
an opening disposed through said beveled member;
a spring-clip member disposed on said front surface, said spring-clip member being fabricated from a clear plastic material; and
a suction cup supported in said opening.

8. The vehicle pass holder according to claim 7, wherein said body member has a length and wherein said spring-clip member is coextensive with the length of said body member.

9. The vehicle pass holder according to claim 7, wherein a pair of legs extend from said bottom edge of said body member.

10. The vehicle pass holder according to claim 7, wherein advertisement indicia is disposed on said planar rear surface.
